(19) United States
(12) Patent Application Publication
(10) Pub. No.: US 2008/0174209 A1
(43) Pub. Date: Jul. 24, 2008

(54) Stepping motor

(76) Inventor: Masaaki Matsubara, Yonago-shi (JP)

Correspondence Address: WENDEROTH, LIND & PONACK, L.L.P., 2033 K STREET N. W., SUITE 800, WASHINGTON, DC, 20006-1021, US

(21) Appl. No.: 12/007,100

(22) Filed: Jan. 7, 2008

(30) Foreign Application Priority Data
Jan. 23, 2007 (JP) 2007-12984

(51) Int. Cl. H02K 37/12; H02K 33/00

(52) U.S. Cl. 310/49 R; 310/81

(57) ABSTRACT

A stepping motor has a stator; and a rotor disposed to surround the stator. The stator includes annular first and second stator yokes disposed to face each other, each having a plurality of pole teeth formed along a circumference thereof, and an annular stator coil disposed between the first and second stator yokes. The rotor includes an annular magnet disposed to surround the first and second stator yokes, which has a plurality of magnetic poles formed along a circumference thereof, and a shaft disposed on a central portion of the magnet. A part of the plurality of pole teeth of the first stator yoke is a first commutating pole which has a width different from the widths of the other pole teeth. A part of the plurality of pole teeth of the second stator yoke is a second commutating pole which has a width different from the widths of the other pole teeth and the first commutating pole, and is disposed adjacent to the first commutating pole. Center lines of gaps between the pole teeth of the first stator yoke are displaced from center lines of the pole teeth of the second stator yoke.

### BACKGROUND OF THE INVENTION

1. Field of the Invention

The present invention relates to a stepping motor including a rotor disposed to surround a stator.

2. Related Art

A stepping motor has a simple structure and is easy to control and is therefore used in various fields. Especially, a PM (Permanent Magnet) stepping motor using a permanent magnet can be manufactured at low cost and is therefore used widely in various fields.

Reliability is important in this type of stepping motor and it is especially required for the stepping motor to start up normally under all conditions. To ensure that the stepping motor starts up normally, it is necessary to control the stepping motor to stop in an exact predetermined position. For high-precision stop position control, detent torque is generally adjusted to be small. This is because the detent torque is a load in rotation.

However, if the load is heavy, e.g., if a weight is used as a load in a stepping motor for generating vibrations, it is difficult to precisely stop the motor in a desired stop position when the motor is not energized. Therefore, there have been proposed techniques for reliably stopping the load by increasing detent toque when the motor is not energized (see Japanese Patent Application Laid-open (JP-A) No. 60-43059, JP-A No. 6-78513, JP-A No. 9-308214).

In an outer-rotor type of single-phase stepping motor among the PM stepping motors, a rotor is disposed to surround an annular stator. The stator has stator yokes formed with a plurality of pole teeth and the rotor has a magnet in which magnetic poles having different polarities are disposed alternately along a circumference thereof.

In the outer-rotor type of stepping motor, stable positions (stop positions) of holding torque are positions where boundaries between adjacent magnetic poles of the magnet substantially match center lines of the pole teeth of the stator yokes. Such positions are provided as many as the number of magnetic poles of the magnet. On the other hand, stable positions (stop positions) of detent torque are positions where the boundaries between adjacent magnetic poles of the magnet or center lines of the respective magnetic poles substantially match the center lines of the pole teeth of the stator yokes. Such positions are provided twice as many as the magnetic poles of the magnet.

If a stable position of the holding torque and a stable position of the detent torque match each other, the stepping motor may not start up normally after the stop. Therefore, it is conceivable to provide commutating poles obtained by expanding or narrowing widths of the pole teeth with regard to a part of the plurality of pole teeth. The commutating poles are provided because, if there are no commutating poles, the single-phase stepping motor may not start up normally or may start up by only a half step when the motor is caused to start up from the stable position. By providing the commutating poles, it is possible to displace the stable positions of the holding torque and the stable positions of the detent torque from each other to stabilize the start.

The commutating poles in the single-phase stepping motor are provided to a part of the plurality of pole teeth of a pair of stator yokes disposed on opposite sides of a stator coil. By providing the commutating poles, phases of the pole teeth between both the stator yokes change and start-up performance is enhanced.

However, even if the commutating poles are provided to adjust the phases, the stable positions of the holding torque and the detent torque change due to positions or sizes of the commutating poles. Moreover, stable positions of the holding torque and the detent torque also change due to variations in manufacturing and assembly.

Moreover, even if the commutating poles are provided, the stable positions of the holding torque and the detent torque may be widened to create so-called dead zones under the influence of frictional loss or the like in some cases. If widths of the dead zones are expanded, the stable positions of the holding torque and the detent torque become likely to match each other to impair the start-up performance.

### SUMMARY OF THE INVENTION

The present invention has been made in view of the above problems and it is an object of the invention to provide a stepping motor having excellent start-up performance. Especially, it is an object of the invention to displace stable positions of holding torque and stable positions of detent torque from each other. Moreover, it is an object of the invention to narrow widths of dead zones of holding torque and detent torque.

According to one aspect of the present invention, a stepping motor, comprising:

a stator; and

a rotor disposed to surround the stator,

wherein the stator includes:

annular first and second stator yokes disposed to face each other, each having a plurality of pole teeth formed along a circumference thereof; and

an annular stator coil disposed between the first and second stator yokes;

wherein the rotor includes:

an annular magnet disposed to surround the first and second stator yokes, which has a plurality of magnetic poles formed along a circumference thereof; and

a shaft disposed on a central portion of the magnet;

wherein a part of the plurality of pole teeth of the first stator yoke is a first commutating pole which has a width different from the widths of the other pole teeth;

a part of the plurality of pole teeth of the second stator yoke is a second commutating pole which has a width different from the widths of the other pole teeth and the first commutating pole, and is disposed adjacent to the first commutating pole; and

center lines of gaps between the pole teeth of the first stator yoke are displaced from center lines of the pole teeth of the second stator yoke.

According to one aspect of the present invention, a stepping motor, comprising:

a stator; and

a rotor disposed to surround the stator,

wherein the stator includes:

annular first and second stator yokes disposed to face each other, each having a plurality of pole teeth formed along a circumference thereof; and

an annular stator coil disposed between the first and second stator yokes;

wherein the rotor includes:

an annular magnet disposed to surround the first and second stator yokes, which has a plurality of magnetic poles formed along a circumference thereof; and

a shaft disposed on a central portion of the magnet;

wherein a part of the plurality of pole teeth of the first stator yoke is a first commutating pole which has a width different from the widths of the other pole teeth;

a part of the plurality of pole teeth of the second stator yoke is a second commutating pole which has a width different from the widths of the other pole teeth and the first commutating pole, and is disposed adjacent to the first commutating pole; and

the second commutating pole is disposed with displacement in a gap adjacent to the first commutating pole.

In the stepping motor according to the present invention, stable positions of holding torque and stable positions of detent torque of the first and second stator yokes do not match each other and thereby start-up performance is enhanced. Moreover, the widths of the dead zones of the holding torque and the detent torque can be narrowed and it is possible to reduce the possibility of matching the stable positions of the holding torque and the stable positions of the detent torque to further enhance the start-up performance.

### BRIEF DESCRIPTION OF THE DRAWINGS

FIG. 1 is a plan view of a stator of a stepping motor according to an embodiment of the present invention;

FIG. 2 is an exploded perspective view of the stepping motor shown in FIG. 1;

FIG. 3 is a perspective view of an assembled state of the stator of the stepping motor shown in FIG. 2;

FIG. 4 is a perspective view of a stator of a stepping motor without commutating poles for comparison;

FIG. 5 is a plan view of a comparative example in which first and second commutating poles 21, 22 are disposed in gaps between pole teeth without deviation;

FIG. 6 is a drawing showing stable positions of the holding torque and the detent torque shown in FIG. 5;

FIG. 7 is a drawing showing an example in which gaps between pole teeth are narrowed;

FIG. 8 is a drawing showing an example in which bases of pole teeth are widened while gaps between the pole teeth are the same as those shown in FIG. 7;

FIG. 9 is a drawing showing an example in which tips of pole teeth are widened while gaps between the pole teeth are the same as those shown in FIG. 7;

FIG. 10 is a drawing showing an example in which all the pole teeth including the first and second commutating poles 21, 22 are disposed while deviated by using the same first and second stator yokes 6, 8 as those shown in FIG. 6;

FIG. 11 is a drawing showing an example in which all the pole teeth including the first and second commutating poles 21, 22 are disposed while deviated under the same conditions as FIG. 8;

FIG. 12 is a drawing showing an example in which pole teeth of first and second stator yokes 6, 8 are displaced from each other in opposite directions of those shown in FIG. 10;

FIG. 13 is a table showing results obtained from FIGS. 6 to 12; and

FIG. 14 is a graph showing a result of magnetic field analysis of the stepping motor in which the first and second commutating poles 21, 22 are disposed while deviated in the gaps between the pole teeth.

### DETAILED DESCRIPTION OF THE INVENTION

An embodiment of the present invention will be described below with reference to the drawings.

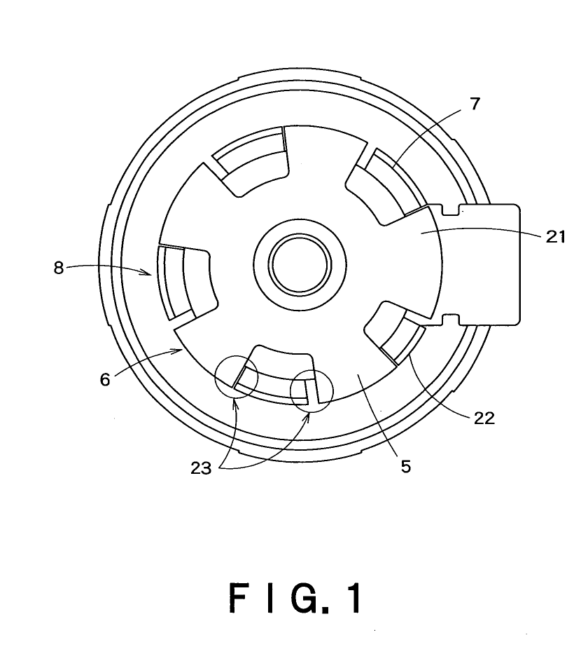

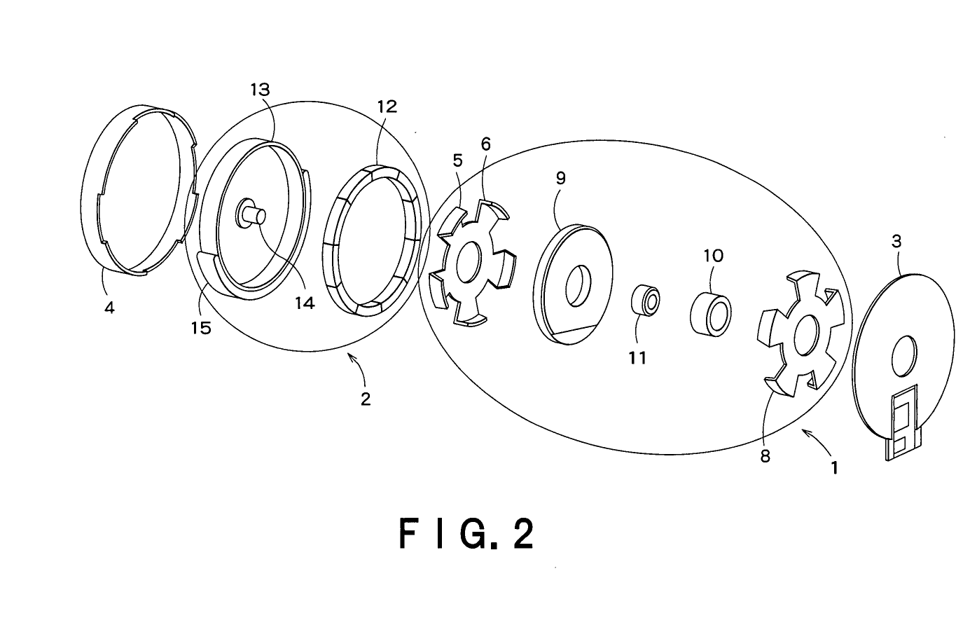

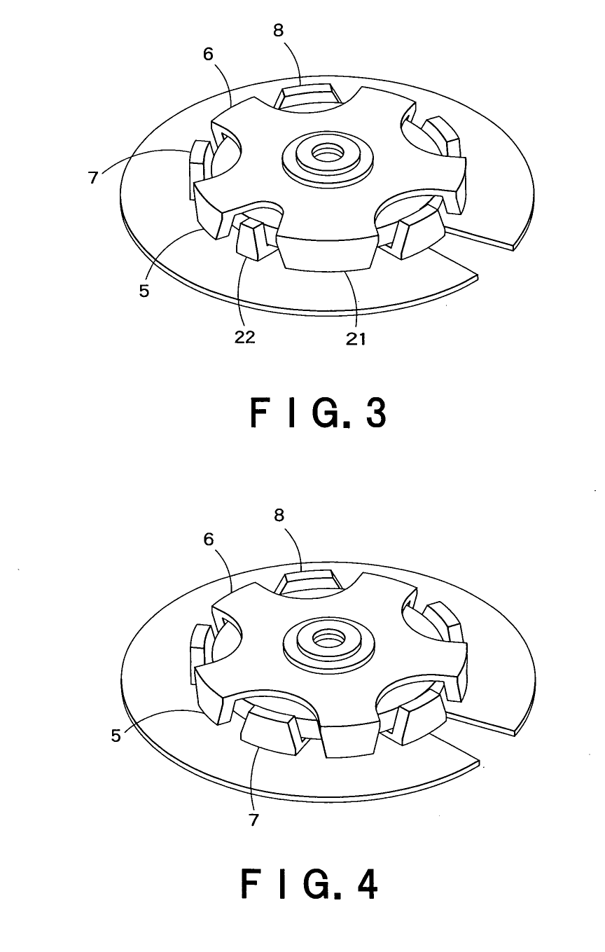

FIG. 1 is a plan view showing a stator of a stepping motor according to the embodiment of the invention. FIG. 2 is an exploded perspective view of the stepping motor shown in FIG. 1. FIG. 3 is a perspective view of an assembled state of the stator of the stepping motor shown in FIG. 2. FIG. 4 is a perspective view of the stator of the stepping motor without commutating poles for comparison.

First, a structure of the stepping motor according to the embodiment will be described using FIG. 2. The stepping motor shown in FIG. 2 is of an outer rotor type and includes a stator 1, a rotor 2 disposed to surround the stator 1, a bracket (bottom plate) 3 for retaining the stator 1 and having a terminal for supplying power, and a cover 4 for protecting the rotor 2.

The stator 1 includes an annular first stator yoke 6 having a plurality of pole teeth 5 along its circumference, an annular second stator yoke 8 disposed to face the first stator yoke 6 and having a plurality of pole teeth 7, a stator coil 9 disposed between the first and second stator yokes 6, 8, a core 10 fitted and inserted into a hole formed in a central portion of the stator coil 9, and a metal bearing 11 fitted and inserted into a hole formed in a central portion of the core 10.

The rotor 2 includes an annular magnet 12 disposed to surround the first and second stator yokes 6, 8, a frame 13 for retaining the magnet 12, a shaft 14 mounted on a central portion of the frame 13, and an eccentric weight 15 for generating vibrations. In the magnet 12, as many magnetic poles as the pole teeth of the stator yokes are formed alternately along its circumference. The frame 13 is formed to cover an outer peripheral portion of the magnet 12 and the eccentric weight 15 is mounted on a part of an outer peripheral face of the frame 13.

By assembling the respective members of FIG. 2, the stator of the stepping motor as shown in FIG. 3 is obtained. FIG. 3 shows a state in which the cover 4 is detached.

The first and second stator yokes 6, 8 are interdigitated, the plurality of pole teeth 7 of the second stator yoke 8 are disposed in gaps between the plurality of pole teeth 5 of the first stator yoke 6, and the plurality of pole teeth 5 of the first stator yoke 6 are disposed in gaps between the plurality of pole teeth 7 of the second stator yoke 8.

In the stepping motor shown in FIG. 2, if an electric current is fed through the stator coil 9, magnetic flux according to a direction of the electric current is generated and the pole teeth 5, 7 of the first and second stator yokes 6, 8 become magnetized. The pole teeth 5, 7 face the magnetic poles of the magnet 12 and the pole teeth 5, 7 and the magnetic poles attract each other in some places and repulse each other in others. Thus, the magnet 12 turns by one magnetic pole (one step). Then, if the direction of the electric current fed through the stator coil 9 is changed, the magnet 12 further turns by one step. In this way, by alternately changing the direction of the electric current fed through the stator coil 9, the magnet 12 rotates by every step.

Next, structures of the first and second stator yokes 6, 8 which are characteristic portions of the invention will be described in detail using FIG. 1. FIG. 1 shows an example in which the second stator yoke 8 is disposed under the first stator yoke 6 with the stator coil 9 sandwiched between them.

As shown in FIG. 1, a part of the plurality of pole teeth of the first stator yoke 6 is a commutating pole (hereafter referred to as first commutating pole 21) and the first commutating pole 21 has a greater width than the other pole teeth 5. Likewise, a part of the plurality of pole teeth 7 of the second stator yoke 8 is a commutating pole (hereafter referred to as second commutating pole 22) and the second commutating pole 22 has a smaller width than the other pole teeth 7. Although FIG. 1 shows the example in which one first commutating pole 21 and one second commutating pole 22 are provided, a plurality of commutating poles may be provided (provided that the number of the first commutating poles is the same as that of the second commutating poles).

The first commutating pole 21 and the second commutating pole 22 are disposed next to each other. More specifically, the second commutating pole 22 is disposed in the gap formed between the first commutating pole 21 and the adjacent pole tooth 5. If a plurality of first commutating poles 21 are provided, the second commutating poles 22 are disposed next to the respective first commutating poles 21.

In the embodiment, the second commutating pole 22 is not disposed at the center of the gap formed between the first commutating pole 21 and the adjacent pole tooth 5 but disposed while deviated to one side in the gap. For example, in FIG. 1, the second commutating pole 22 is disposed along a lower boundary of the gap.

Thus, as shown in FIG. 1, the plurality of pole teeth 7 of the second stator yoke 8 are disposed while deviated in the respective gaps between the plurality of pole teeth of the first stator yoke 6 and clearances 23 having different widths are formed on opposite sides of each pole tooth 7. As a result, stable positions of holding torque and stable positions of detent torque of the first and second stator yokes 6, 8 do not match each other and thereby start-up performance is enhanced.

As described above, the embodiment is characterized in that center lines of the gaps between the plurality of pole teeth 5 of the first stator yoke 6 are displaced from center lines of the pole teeth of the second stator yoke 8. The first commutating pole 21 and second commutating pole 22 do not necessarily have to be disposed in the positions shown in FIG. 1.

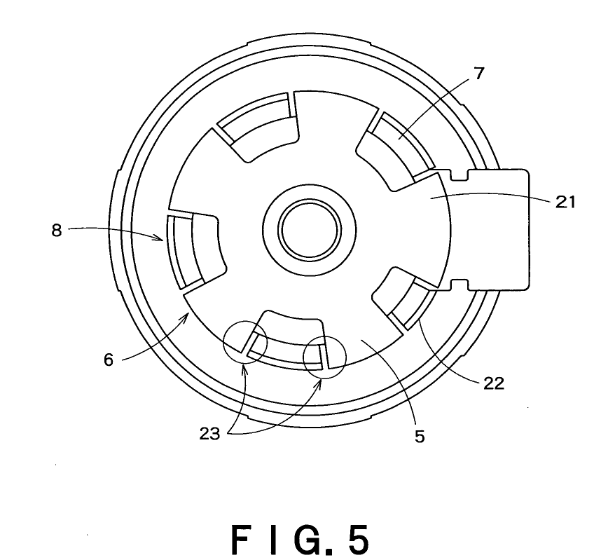

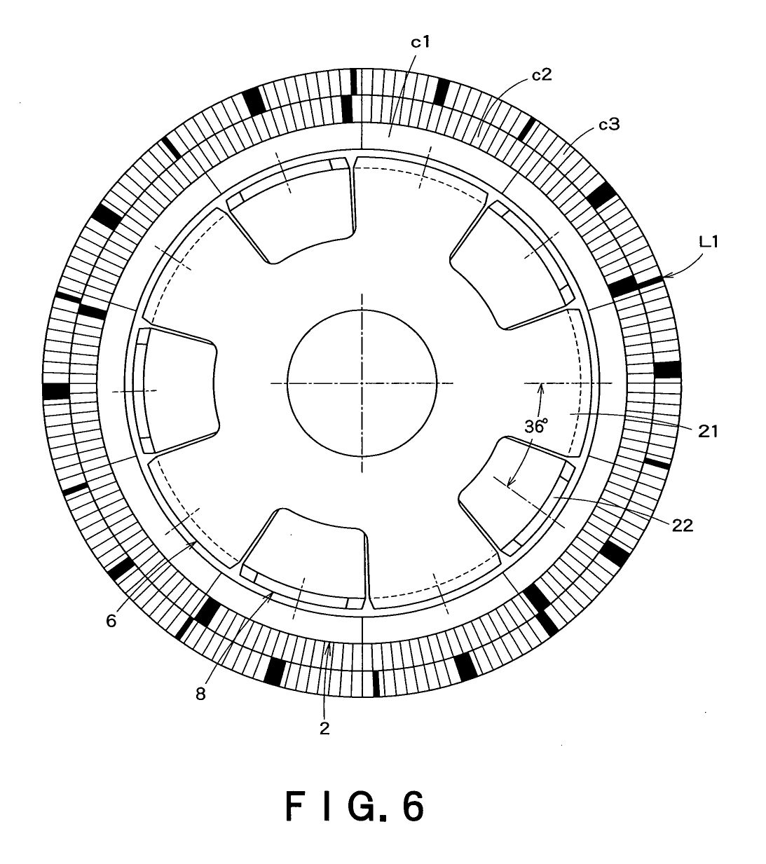

FIG. 5 is a plan view of a comparative example in which the first and second commutating poles 21, 22 are disposed in the gaps between the pole teeth without deviation and FIG. 6 is a drawing showing stable positions of the holding torque and the detent torque shown in FIG. 5. In FIG. 6, the magnetic poles of the magnet 12 are shown on a circumference c1, the stable positions of the holding torque are blacked on a circumference c2, and the stable positions of the detent torque are blacked on a circumference c3. As shown in the drawing, there are ten magnetic poles of the magnet 12 in total, five stable positions of the holding torque in total, and ten stable positions of the detent torque in total. In the example of FIG. 6, an angle between the adjacent pole teeth is 36° and an angle between the first and second commutating poles 21, 22 is also 36°. In the case of FIG. 6, the gap between the adjacent pole teeth is set to be about three times as wide as a gap between the rotor 2 and the first and second stator yokes 6, 8.

As shown in FIG. 6, if all the pole teeth including the first and second commutating poles 21, 22 are disposed in the gaps without deviation, the stable positions of the holding torque and the stable positions of the detent torque match each other in a few positions (position L1 in FIG. 6).

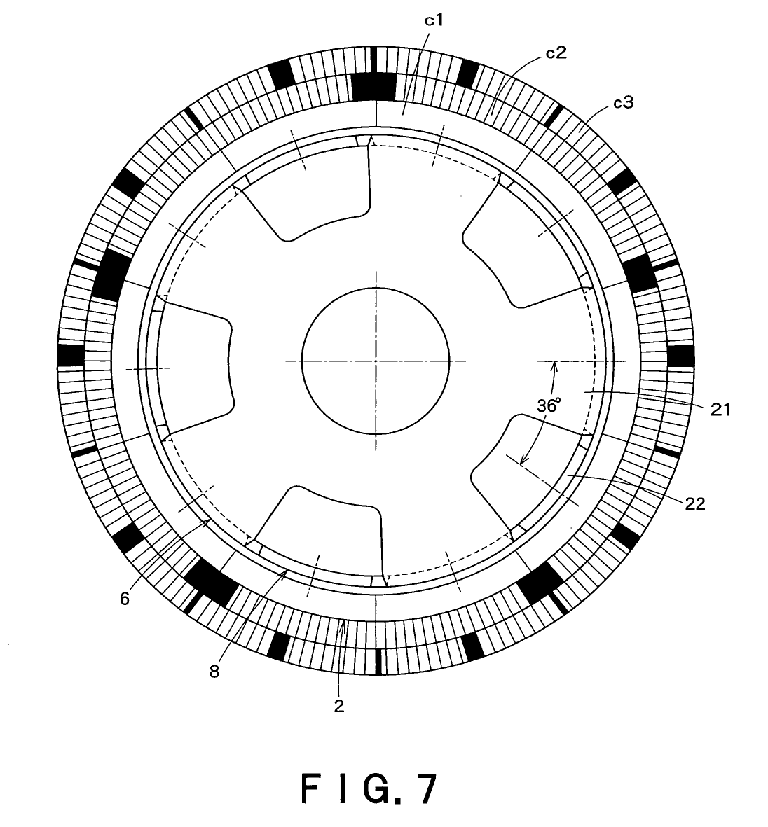

FIG. 7 is a drawing showing an example in which the gaps between the pole teeth are narrower than those of FIG. 6. In this case, all the pole teeth are disposed in the gaps without deviation again. However, since the gaps between the pole teeth are narrowed, widths of the stable positions of the holding torque, i.e., widths of dead zones expand. It is preferable to make the widths of the dead zones as narrow as possible. In the case of FIG. 7, the gaps between the adjacent pole teeth are set to be about twice as wide as the gap between the rotor 2 and the first and second stator yokes 6, 8. As can be seen from FIG. 7, by narrowing the gaps between the pole teeth, the widths of the dead zones expand. Therefore, the wider the gaps between the pole teeth, the narrower the widths of the dead zones become. More specifically, it is preferable that the gaps between the pole teeth are about three times as wide as the gap between the rotor 2 and the first and second stator yokes 6, 8.

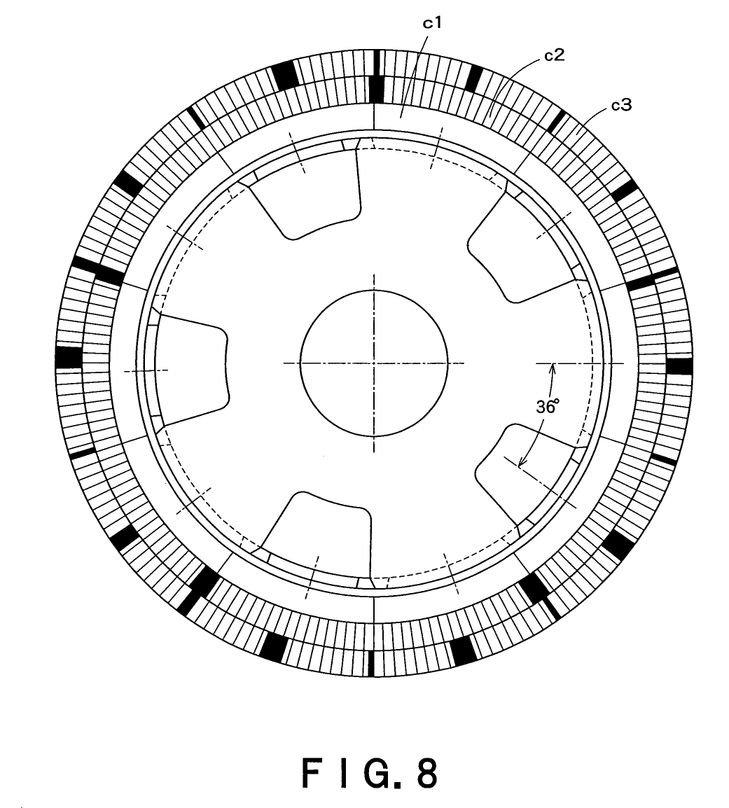

FIG. 8 is a drawing showing an example in which bases of pole teeth are widened while gaps between the pole teeth are the same as those of FIG. 7. In this case, all the pole teeth are disposed in the gaps without deviation again. However, by widening the bases of the pole teeth, widths of dead zones become narrower than those of FIG. 7 as shown in FIG. 8. This shows that the pole teeth with wider bases are better.

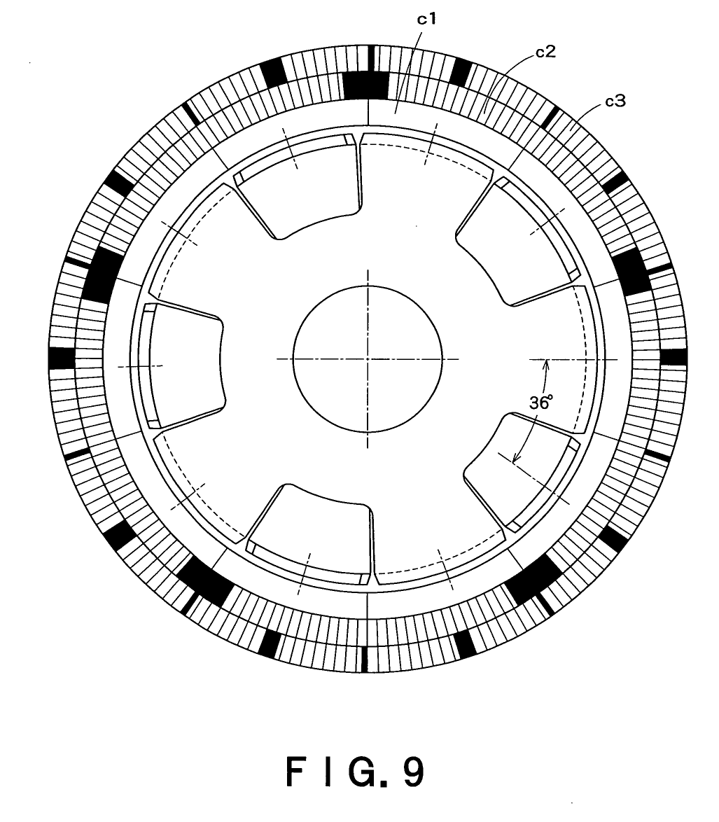

FIG. 9 is a drawing showing an example in which tips of the pole teeth are widened while gaps between the pole teeth are the same as those of FIG. 7. In this case, all the pole teeth are disposed in the gaps without deviation again. However, by widening the tips of the pole teeth, widths of dead zones become greater than those of FIG. 7 as shown in FIG. 9. This shows that the pole teeth with narrower tips are better.

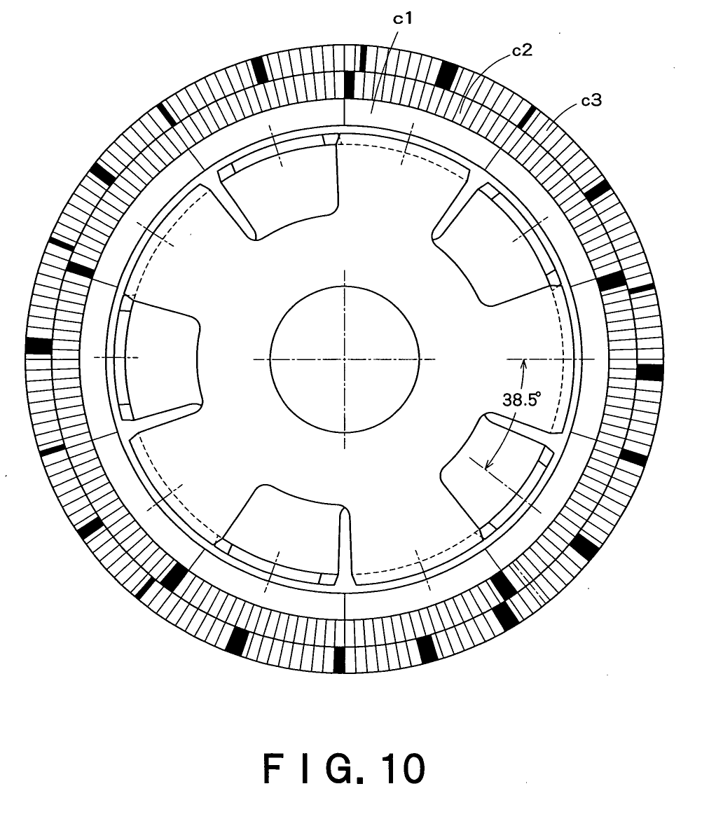

FIG. 10 is a drawing showing an example in which all the pole teeth including the first and second commutating poles 21, 22 are disposed while deviated by using the same first and second stator yokes 6, 8 as those in FIG. 6. In this case, unlike the case of FIG. 6, the stable positions of the holding torque and the stable positions of the detent torque do not match each other. Therefore, it is apparent that the start-up performance is enhanced if the first and second commutating poles 21, 22 are disposed while deviated.

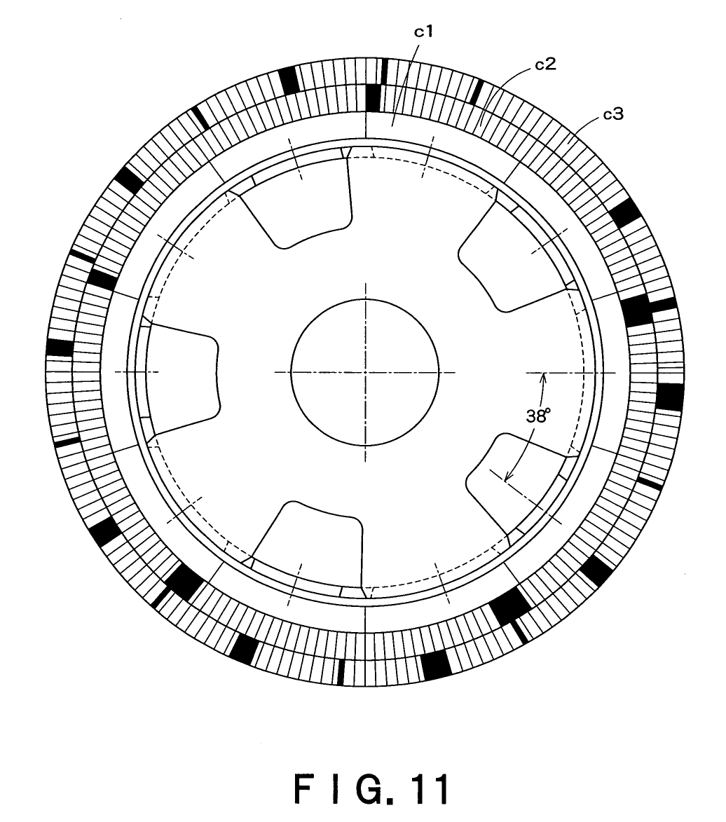

FIG. 11 is a drawing showing an example in which all the pole teeth including the first and second commutating poles 21, 22 are disposed while deviated under the same conditions as FIG. 8. In this case, because the widths of the dead zones of the holding torque are large, it is impossible to completely displace the stable positions of the holding torque and the stable positions of the detent torque from each other.

From the above description, it is apparent that the case of FIG. 10 is the most excellent in start-up performance among the cases of FIGS. 6 to 11. In FIG. 10, by disposing the first and second commutating poles 21, 22 while deviated in the gaps between the pole teeth, the stable positions of the holding torque and the stable positions of the detent torque are displaced from each other. Moreover, by adjusting at least one of the width of each gap between the pole teeth, the width of the base of each pole tooth, and the width of the tip of each pole tooth, the widths of the dead zones of the holding torque and the detent torque are adjusted.

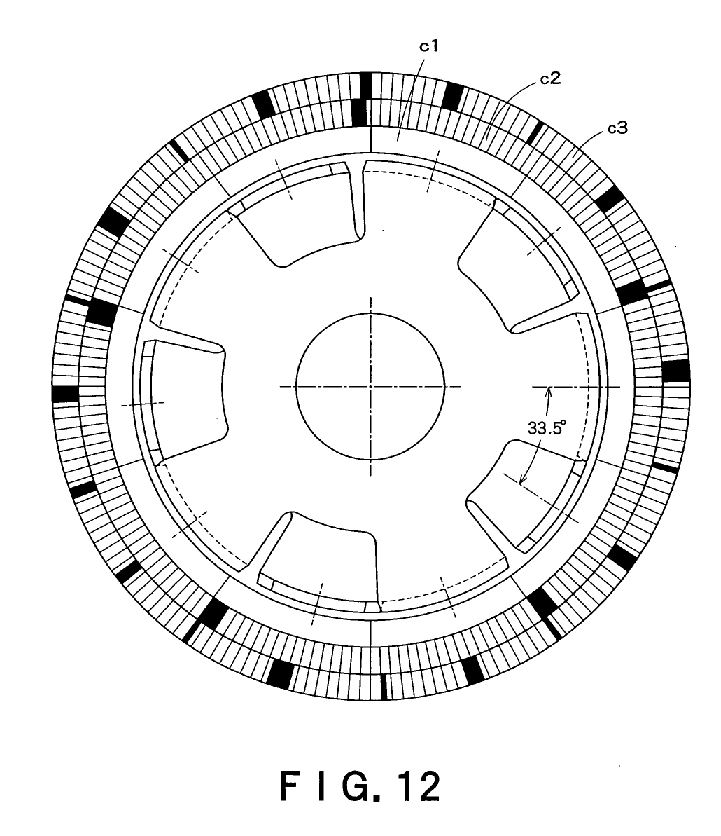

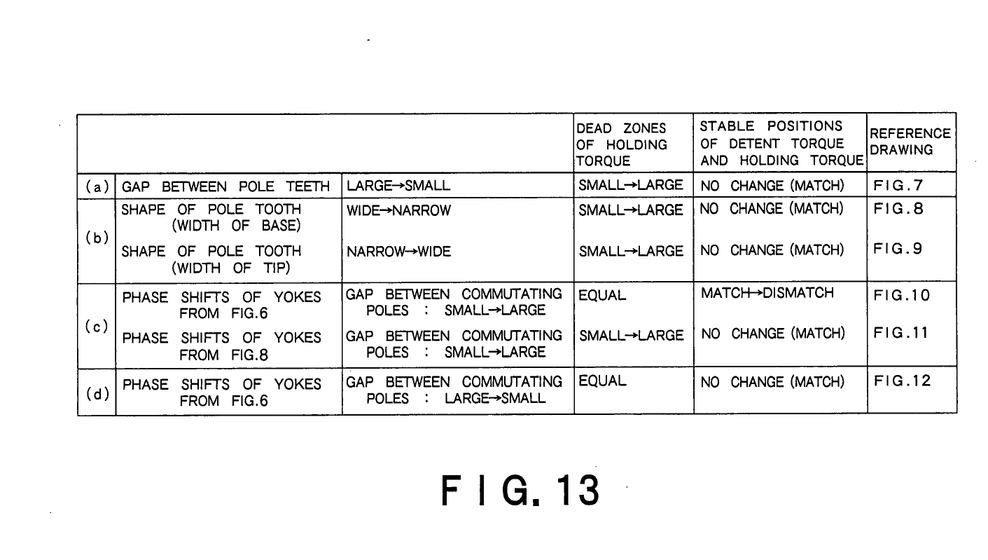

FIG. 12 is a drawing showing an example in which the pole teeth of the first and second stator yokes 6, 8 are displaced from each other in opposite directions of those of FIG. 10. In the case of FIG. 12, although amounts of displacement of the pole teeth of the first stator yoke 6 and the pole teeth of the second stator yoke 8 from each other are equal to those in the case of FIG. 10, the widths of the dead zones of the holding torque are much greater than those of FIG. 10 and the stable positions of the holding torque and the stable positions of the detent torque overlap each other.

As described above, simple displacement of the pole teeth of the first and second stator yokes 6, 8 from each other does not necessarily produce the effect. Directions of displacement are also important. More specifically, the pole teeth need to be displaced from each other in a direction where the gap between the first and second commutating poles 21, 22 widens as shown in FIG. 10.

FIG. 13 is a table showing results obtained from FIGS. 6 to 12 and the following conclusions (a) to (d) are obtained.

(a) If the gaps between the pole teeth are made small, the widths of the dead zones of the holding torque increase (see FIGS. 6 and 7). However, by simply changing the gaps, the stable positions of the holding torque and the stable positions of the detent torque do not change.

(b) The narrower the widths of the base of the pole teeth and the wider the widths of the tips of the pole teeth, the greater the widths of the dead zones of the holding torque become (see FIGS. 8 and 9). However, by simply changing the shapes of the pole teeth, the stable positions of the holding torque and the stable positions of the detent torque do not change.

(c) If positions of the pole teeth of the first stator yoke 6 and the pole teeth of the second stator yoke 8 with respect to each other are displaced from the state of FIG. 6 to widen the gap between the first and second commutating poles 21, 22, the stable positions of the holding torque and the stable positions of the detent torque are displaced from each other, though values of the holding torque are equal, as shown in FIG. 10. On the other hand, if the positions of the pole teeth of the first stator yoke 6 and the pole teeth of the second stator yoke 8 with respect to each other are displaced from the state of FIG. 8 to widen the gap between the first and second commutating poles 21, 22, the widths of the dead zones of the holding torque are widened but the stable positions of the holding torque and the stable positions of the detent torque do not change as shown in FIG. 11.

(d) If the positions of the pole teeth of the first stator yoke 6 and the pole teeth of the second stator yoke 8 with respect to each other are displaced from the state of FIG. 6 to narrow the gap between the first and second commutating poles 21, 22, the stable positions of the holding torque and the stable positions of the detent torque become more likely to overlap each other, though values of the holding torque are equal, as shown in FIG. 12.

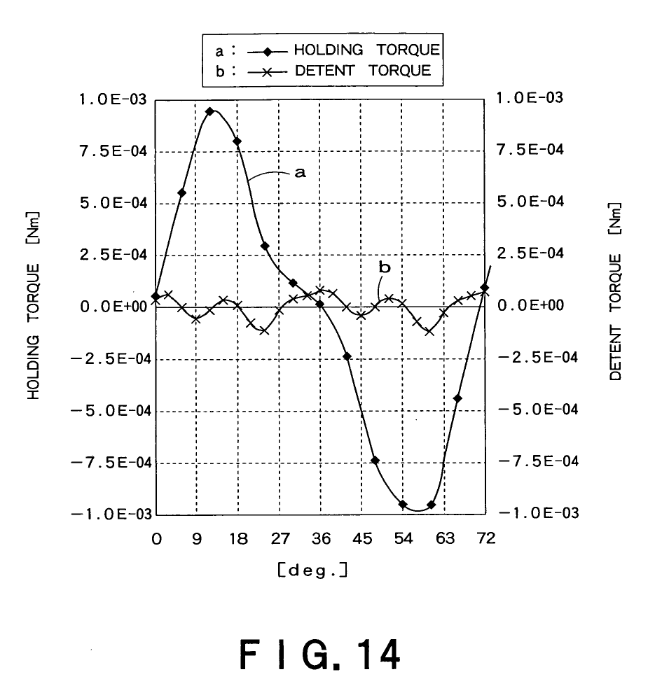

FIG. 14 is a graph showing a result of magnetic field analysis of the stepping motor in which the first and second commutating poles 21, 22 are disposed while deviated in the gaps between the pole teeth. A curve “a” is a characteristic curve of the holding torque and a curve “b” is a characteristic curve of the detent torque. A horizontal axis represents a position (angle) on the circumference [deg.] and a vertical axis represents torque [Nm] in FIG. 14.

Points of intersection of the curves “a”, “b” and a straight line of torque=0 represent the stable positions. As shown in the graph, the stable positions of the holding torque and the stable positions of the detent torque do not match each other.

As described above, because the first and second stator yokes 6, 8 are displaced from each other in predetermined directions to displace the center lines of the gaps between the pole teeth of the first stator yoke 6 from the center lines of the pole teeth of the second stator yoke 8 in the embodiment, it is possible to reliably displace the stable positions of the holding torque and the stable positions of the detent torque from each other and the problem in that the stepping motor does not start up can be solved, thereby enhancing the start-up performance.

Moreover, by adjusting at least one of the width of each gap between the pole teeth 5, 7, the width of the base of each of the pole teeth 5, 7, and the width of the tip of each of the pole teeth 5, 7, the widths of the dead zones of the holding torque and the detent torque can be narrowed and it is possible to reduce the possibility of matching the stable positions of the holding torque and the stable positions of the detent torque to further enhance the start-up performance.

What is claimed is:

1. A stepping motor, comprising:
a stator; and
a rotor disposed to surround the stator,
wherein the stator includes:
annular first and second stator yokes disposed to face each other, each having a plurality of pole teeth formed along a circumference thereof; and
an annular stator coil disposed between the first and second stator yokes;
wherein the rotor includes:
an annular magnet disposed to surround the first and second stator yokes, which has a plurality of magnetic poles formed along a circumference thereof; and
a shaft disposed on a central portion of the magnet;
wherein a part of the plurality of pole teeth of the first stator yoke is a first commutating pole which has a width different from the widths of the other pole teeth;
a part of the plurality of pole teeth of the second stator yoke is a second commutating pole which has a width different from the widths of the other pole teeth and the first commutating pole, and is disposed adjacent to the first commutating pole; and
center lines of gaps between the pole teeth of the first stator yoke are displaced from center lines of the pole teeth of the second stator yoke.

2. The stepping motor according to claim 1,
wherein the first and second stator yokes are disposed to widen a gap between the first and second commutating poles, compared with the gap between the first and second commutating poles in a case of disposing the pole teeth of the second stator yoke uniformly in the gaps between the pole teeth of the first stator yoke.

3. The stepping motor according to claim 1,
wherein the gaps between the plurality of pole teeth are adjusted to narrow widths of dead zones, compared with the widths of the dead zones of a holding torque and a detent torque in a case of disposing the pole teeth of the second stator yoke without displacement in the gaps between the pole teeth of the first stator yoke.

4. The stepping motor according to claim 1,
wherein widths of bases of the plurality of pole teeth are adjusted to minimize widths of dead zones of a holding torque and a detent torque.

5. The stepping motor according to claim 1,
wherein widths of tips of the plurality of pole teeth are adjusted to minimize widths of dead zones of a holding torque and a detent torque.

6. The stepping motor according to claim 1, further comprising:
an eccentric weight which generates vibrations.

7. The stepping motor according to claim 1,
wherein the first stator yoke and the second stator yoke are disposed to displace positions of the dead zones of the holding torque and the detent torque.

8. A stepping motor, comprising:
a stator; and
a rotor disposed to surround the stator,
wherein the stator includes:
annular first and second stator yokes disposed to face each other, each having a plurality of pole teeth formed along a circumference thereof; and
an annular stator coil disposed between the first and second stator yokes;
wherein the rotor includes:
an annular magnet disposed to surround the first and second stator yokes, which has a plurality of magnetic poles formed along a circumference thereof; and
a shaft disposed on a central portion of the magnet;
wherein a part of the plurality of pole teeth of the first stator yoke is a first commutating pole which has a width different from the widths of the other pole teeth;
a part of the plurality of pole teeth of the second stator yoke is a second commutating pole which has a width different from the widths of the other pole teeth and the first commutating pole, and is disposed adjacent to the first commutating pole; and
the second commutating pole is disposed with displacement in a gap adjacent to the first commutating pole.

9. The stepping motor according to claim 8,
wherein the first and second stator yokes are disposed to widen a gap between the first and second commutating poles, compared with the gap between the first and second commutating poles in a case of disposing the pole teeth of the second stator yoke uniformly in the gaps between the pole teeth of the first stator yoke.

10. The stepping motor according to claim 8,
wherein the gaps between the plurality of pole teeth are adjusted to narrow widths of dead zones, compared with the widths of the dead zones of a holding torque and a detent torque in a case of disposing the pole teeth of the second stator yoke without displacement in the gaps between the pole teeth of the first stator yoke.

11. The stepping motor according to claim 8,
wherein widths of bases of the plurality of pole teeth are adjusted to minimize widths of dead zones of a holding torque and a detent torque.

12. The stepping motor according to claim 8,
wherein widths of tips of the plurality of pole teeth are adjusted to minimize widths of dead zones of a holding torque and a detent torque.

13. The stepping motor according to claim 8, further comprising:
an eccentric weight which generates vibrations.

14. The stepping motor according to claim 8,
wherein the first stator yoke and the second stator yoke are disposed to displace positions of the dead zones of the holding torque and the detent torque.
